(19) United States
(12) Patent Application Publication
(10) Pub. No.: US 2025/0164371 A1
(43) Pub. Date: May 22, 2025

(54) WATER FILLING AND DRAINAGE TEST METHOD AND DEVICE FOR PREFABRICATED CRACK-CONTAINING REINFORCED CONCRETE LINING PRESSURE TUNNEL

(71) Applicants: ENG CST MAN BR OF CN STN PWRGRID PWR GEN CO. LTD., Guangzhou (CN); CHINA INSTITUTE OF WATER RESOURCES AND HYDROPWR RESEARCH, Beijing (CN); GUANGXI UNIVERSITY, Nanning (CN)

(72) Inventors: Xueshan LIU, Guangzhou (CN); Qiang ZHANG, Guangzhou (CN); Peng ZHANG, Guangzhou (CN); Zhi ZHENG, Guangzhou (CN); Xiaogang WANG, Guangzhou (CN); Zhengyun QIN, Guangzhou (CN); Kai GUO, Guangzhou (CN); Dingcai PAN, Guangzhou (CN); Gang ZHOU, Guangzhou (CN); Yujie WANG, Guangzhou (CN); Yueyang ZHENG, Guangzhou (CN); Yufei HUANG, Guangzhou (CN); Yunli SHI, Guangzhou (CN); Chunhua SONG, Guangzhou (CN); Pengtao YING, Guangzhou (CN); Qiqi ZHANG, Guangzhou (CN); Hecheng HUANG, Guangzhou (CN); Lipeng LIU, Guangzhou (CN)

(73) Assignees: ENG CST MAN BR OF CN STN PWRGRID PWR GEN CO. LTD., Guangzhou (CN); CHINA INST OF WATER RESOURCES AND HYDROPWR RES, Beijing (CN); GUANGXI UNIVERSITY, Nanning (CN)

(21) Appl. No.: 18/832,745

(22) PCT Filed: Aug. 29, 2023
(86) PCT No.: PCT/CN2023/115549

§ 371 Date: Jul. 24, 2024

(30) Foreign Application Priority Data
Sep. 26, 2022 (CN) 202211174554.4

(51) Int. Cl. G01N 15/08

(52) U.S. Cl. CPC G01N 15/0806; G01N 15/082

(57) ABSTRACT

Disclosed in the present invention is a water filling and drainage test device and method for a prefabricated crack-containing reinforced concrete lining pressure tunnel. The test device comprises a cylindrical barrel, a reinforced concrete lining containing prefabricated cracks, surrounding rock, geotechnical cloth, a front flange, a rear flange, and a monitoring instrument. The surrounding rock is proximate to an inner wall of the cylindrical barrel, and the reinforced concrete lining containing the prefabricated cracks is inside of the surrounding rock; and the front flange and the rear flange are fixed at two ends of the cylindrical barrel. The test device is used for carrying out a water filling and drainage test on the pressure tunnel, and observing the change in the width of the prefabricated cracks and the conditions of the pressure tunnel.

### CROSS-REFERENCE TO RELATED APPLICATIONS

This application is a U.S. National Phase Application under 35 U.S.C. § 371 of International Patent Application No. PCT/CN2023/115549, filed on Aug. 29, 2023, which itself claims priority to Chinese Patent Application No. 202211174554.4, filed on Sep. 26, 2022. The contents of the above identified applications are hereby incorporated herein in their entireties by reference.

### TECHNICAL FIELD

The present disclosure relates to water filling and drainage test devices and test methods taking a reinforced concrete lining pressure tunnel model as a research object, in particular to a water filling and drainage test device and a water filling and drainage test method taking a reinforced concrete lining pressure tunnel model including prefabricated crack as a research object. The present disclosure belongs to the technical field of permeable lining pressure tunnel engineering in water conservancy and hydropower engineering.

### BACKGROUND

High-head pressure tunnel is an important part of water diversion system of hydropower station and pumped storage power station, and the design of tunnel lining structure is the key and difficult point of engineering construction. In recent years, reinforced concrete lining is a commonly used lining structure for the high-head pressure tunnel. However, due to the action of high head, the concrete lining of pressure tunnel will crack and become permeable, and the lining of pressure tunnel will separate from surrounding rock under the action of high seepage flow, resulting in significant changes in the operation mechanism and hydraulic conduction characteristics of the pressure tunnel, which will cause certain hidden dangers to the safety of the pressure tunnel during its service life.

Especially, at present, after the concrete lining of the pressure tunnel cracks, how does a change in a width of a crack of the lining during the filling and drainage process of the tunnel? How does the lining and surrounding rock work together? And how do the two share the water load? The understanding of engineering designers in the industry is not clear.

As far as the current research situation is concerned, there are few physical model tests on concrete lining pressure tunnels, which are still in the exploratory stage, and the existing model test devices can not effectively monitor the change in the width of the crack of the lining. Due to the influence of construction quality, temperature effect and the adhesion degree between the lining and the surrounding rock, a cracking position of the concrete lining pressure tunnel under the action of high head shows great randomness, and the cracking position of the lining cannot be predicted before the test. Therefore, the current test device cannot accurately and effectively monitor the change in the width of the crack of the lining by pre-arranging crack gauges. Even if several continuous optical fiber sensors are laid in the lining, since they are easy to be damaged in the lining pouring process and often fail in the test, they can not effectively monitor the change in the width of the crack. Therefore, the existing model test device is difficult to capture the changing pattern of the width of the crack of the pressure tunnel lining during the filling and drainage process.

The stress evolution of concrete lining and reinforcement during tunnel filling and drainage is closely related to the position of lining crack, as mentioned above. Since the crack position of the lining cannot be predicted before the test, the monitoring instruments such as strain gauges and reinforcement meters pre-arranged during the test have great contingency, which makes it difficult to monitor the stress changes at the cracked portions of the lining and other uncracked portions during the test, so the existing model test devices can not accurately reveal the true operation characteristics of the reinforced concrete lining pressure tunnel during the filling and drainage process. In addition, most of the existing physical model tests are water filling tests, which mainly focus on the cracking characteristics of the reinforced concrete lining and the stress of the lining structure during filling water, but not on the flow of high-pressure water in a gap between the lining and the surrounding rock after the lining cracks and the change of the contact state between the lining and the surrounding rock caused thereby, as well as the interaction between the lining and the surrounding rock and the change of its bearing characteristics during the drainage process.

Since the existing model test device can not effectively monitor the change process of the width of the lining crack, engineering designers and constructors can not obtain the true operation characteristics of the reinforced concrete lining pressure tunnel during the filling and drainage process, as well as the interaction between the lining and the surrounding rock and the change of its bearing characteristics during the filling and drainage process.

Therefore, in order to ensure the safety and rationality of the design of the reinforced concrete lining pressure tunnel, there is an urgent need for a device that simulates the filling and drainage test of the concrete lining pressure tunnel after cracks occur, so as to check whether the operation characteristics of the concrete lining pressure tunnel after cracks occur under the filling and drainage conditions meets the design requirements, and provide valuable reference for the design of concrete lining pressure tunnel.

### SUMMARY

In view of the shortcomings of the existing physical model test and test device of high head concrete lining pressure tunnel, an object of the present disclosure is to provide a water filling and drainage test device and a water filling and drainage test method for a reinforced concrete lining pressure tunnel with a prefabricated crack. The test device can simulate the filling and drainage operation state of the reinforced concrete lining pressure tunnel after the crack occurs, and accurately capture the change of a width of a lining crack of the reinforced concrete lining pressure tunnel during the water filling and drainage operation process, and the resulting dynamic evolution of water seepage in the pressure tunnel, the stress of the lining structure and the contact state between the lining and the surrounding rock.

In order to achieve the above object, the present disclosure adopts the following technical scheme: a water filling and drainage test device for reinforced concrete lining pressure tunnel with prefabricated crack, including a cylindrical body, a reinforced concrete lining with a prefabricated crack, a surrounding rock, a geotextile, a front flange, a rear flange, and monitoring instruments;
wherein the cylindrical body is a rigid metal cylinder, and a wall thickness d_{threshold} of the cylindrical body satisfies the following requirements:

$${d}_{t h r e s h o l d} \geq 1.05 d \qquad ( 1 )$$

wherein d_{threshold} and dare a design value and a standard value (m) of the wall thickness of the cylindrical body, respectively, and dis determined by the following formula:

$$d = {r}_{s} ( 1 - \sqrt{\frac{{σ}_{s}^{t} - {p}_{t}}{{σ}_{s}^{t} + {p}_{t}}} ) \qquad ( 2 )$$

wherein rₛ is an outer diameter (unit: m) of the cylindrical body, σₛ^{t} is a ultimate tensile strength (unit: MPa) of steel used for the cylindrical body, and Pₜ is a design head of a pressure tunnel (unit: MPa);
wherein the surrounding rock abuts against an inner wall of the cylindrical body, the reinforced concrete lining with prefabricated crack is provided on an inner side of the surrounding rock, and the front flange and the rear flange are respectively fixed to both ends of the cylindrical body to form a closed internal water loading cavity capable of being filled and drained;
wherein the monitoring instruments include a crack gauge configured to monitor a change in a width of the crack during the filling and draining process, a reinforcement meter, a strain gauge, an osmometer, and a soil pressure gauge that are configured to monitor an operation condition in the pressure tunnel, and the monitoring instruments are provided in an inner wall of the crack, in the reinforced concrete lining, and between the reinforced concrete lining and the surrounding rock;
wherein the geotextile is laid between the surrounding rock and the reinforced concrete lining, and a thickness of the geotextile is configured such that a circumferential stress σ_{θ} and a circumferential strain ε_{θ} of the reinforced concrete lining with the prefabricated crack satisfy the following relationship:

$${σ}_{θ 1} < {σ}_{θ} < {σ}_{θ 2} \qquad ( 3 )$$

$${ε}_{θ 1} < {ε}_{θ} < {ε}_{θ 2} \qquad ( 4 )$$

wherein σ_{θ1} and ε_{θ1} are a circumferential stress and a circumferential strain of an outer wall of the reinforced concrete lining with the prefabricated crack under rigid constraint, respectively;
wherein σ_{θ2} and ε_{θ2} are a circumferential stress and a circumferential strain of the lining when the outer wall of the reinforced concrete lining with the prefabricated crack is a free boundary, respectively;
wherein σ_{θ1}, ε_{θ1}, σ_{θ2} and ε_{θ2} are determined from the following formulas:

$${σ}_{θ 1} = \frac{\frac{1 - 2 υ}{{r}^{2}} - \frac{1}{{b}^{2}}}{\frac{1 - 2 υ}{{a}^{2}} + \frac{1}{{b}^{2}}} {p}_{crack} \qquad ( 5 )$$

$${ε}_{θ 1} = \frac{( 1 - 2 υ ) ( 1 + υ )}{E} \frac{\frac{1}{{r}^{2}} - \frac{1}{{b}^{2}}}{\frac{1 - 2 υ}{{a}^{2}} + \frac{1}{{b}^{2}}} {p}_{crack} \qquad ( 6 )$$

$${σ}_{θ 2} = \frac{{a}^{2} {b}^{2} {p}_{crack}}{{b}^{2} - {a}^{2}} \frac{1}{{r}^{2}} + \frac{{a}^{2} {p}_{crack}}{{b}^{2} - a} \qquad ( 7 )$$

$${ε}_{θ 2} = \frac{1}{E} [ ( 1 + υ ) \frac{{a}^{2} {b}^{2} {p}_{crack}}{{b}^{2} - {a}^{2}} \frac{1}{{r}^{2}} + ( 1 - υ ) \frac{{a}^{2} {p}_{crack}}{{b}^{2} - {a}^{2}} ] \qquad ( 8 )$$

wherein p_{crack} is an estimated value of internal water pressure (unit: MPa) when a pressure tunnel lining cracks;
a is an inner diameter of the reinforced concrete lining with the prefabricated crack, b is an outer diameter of the reinforced concrete lining with the prefabricated crack, and r is a distance from any point in the reinforced concrete lining with the prefabricated crack to a center thereof;
v is a Poisson's ratio of a material of the reinforced concrete lining with the prefabricated crack;
E is an elastic modulus of the material of the reinforced concrete lining with prefabricated crack.

Preferably, the reinforced concrete lining with the prefabricated crack is formed by pouring and curing concrete, a plurality of circumferential steel bars are spaced apart in the reinforced concrete lining perpendicular to a longitudinal axis of the pressure tunnel, a plurality of longitudinal steel bars are spaced apart in the reinforced concrete lining parallel to the longitudinal axis of the tunnel, and a crack is preset on an inner wall of the reinforced concrete lining.

Preferably, in the reinforced concrete lining with the prefabricated crack, five monitoring sections A-A, B-B, C-C, D-D, and E-E perpendicular to an axis of the pressure tunnel are selected at intervals along the axis of the pressure tunnel;
the crack gauge is arranged at the crack of the monitoring section with the prefabricated crack;
taking a top center of the cylindrical body as a direction of 0°, the reinforcement meter and the strain gauge are respectively arranged at positions of 350°, 20°, 90°, 135° and 180° of the monitoring sections A-A, B-B, C-C, D-D and E-E in a clockwise direction, and a distance between the reinforcement meter and a central axis of the pressure tunnel is equal to a distance between the strain gauge and a central axis of the pressure tunnel on each monitoring section;
taking the top center of the cylindrical body as the direction of 0°, the soil pressure gauge and the osmometer are respectively arranged at positions of 340°, 5°, 90°, 135° and 180° of the monitoring sections A-A, B-B, C-C, D-D and E-E in the clockwise direction and on an outer wall of the lining, and a distance between the soil pressure gauge and the osmometer is 6 cm.

Preferably, the reinforcement meter is bound or welded to the circumferential steel bar, the strain gauge is embedded in the reinforced concrete lining, and the soil pressure gauge and the osmometer are arranged on the outer wall of the reinforced concrete lining.

Preferably, a depth of the crack is 6 cm, and distances between both ends of the crack and both ends of the cylindrical body are 15 cm.

Preferably, an outer side of the front flange is provided with a plurality of reinforcing ribs, the outer side of the front flange is provided with bolt holes configured to be connected to the cylindrical body, a pressure gauge is mounted in a middle area of the front flange corresponding to hole of the pressure tunnel, and an internal water loading joint and a cable guiding hole are provided in the middle area of the front flange;
an outer side of the rear flange is also provided with a plurality of reinforcing ribs, the outer side of the rear flange is provided with bolt holes configured to be connected to the cylindrical body, and an inner cavity drainage joint is provided in a middle area of the rear flange corresponding to hole of the pressure tunnel;
sealing rings are provided between the front flange, the rear flange, and the cylindrical body.

A method for performing a water filling and drainage test for pressure tunnel using the above-mentioned water filling and drainage test device for reinforced concrete lining pressure tunnel with prefabricated crack, includes the following steps:
S1, filling and draining water into an internal water loading cavity formed by the test device step by step to simulate an operating state of water pressure loading and unloading in the pressure tunnel;
connecting a pressurized water pump to an internal water loading joint of the front flange, filling the internal water loading cavity with water step by step, and opening the inner cavity drainage joint of the rear flange to drain the water step by step when step-by-step filling stage is completed;
wherein a number of water filling steps, a total number of water filling steps, and a total number of filling and drainage steps when the water filling pressure is 0.5 Mpa are as follows:

$${S}_{l} = \frac{{p}_{l}}{Δ p} \qquad ( 9 )$$

$$S = \frac{{p}_{t}}{Δ p} \qquad ( 10 )$$

$${S}_{total} = 2 \times S \qquad ( 11 )$$

wherein S₁ is a number of steps when the water filling pressure is equal to 0.5 Mpa, S is a total number of water filling steps, Sₜₒₜₐₗ is a total number of water filling and drainage steps, P₁ is a water filling pressure of 0.5 Mpa, pₜ is a design head of the pressure tunnel (unit: MPa), which is 1.5 MPa, and Δp is a loading and unloading amplitude (unit: MPa) of step-by-step water filling and drainage pressure, which is 0.05 MPa;
wherein when the internal water loading cavity is filled and drained step by step, a duration of pressurization or depressurization of each stage of filling and draining is:

$${T}_{k} = \{ \begin{matrix}120 s & , & 0 < k \leq {S}_{l} \\ 240 s & , & {S}_{l} < k \leq S \\ 120 s & , & S < k \leq {S}_{total}\end{matrix} \qquad ( 12 )$$

wherein Tₖ is the duration of pressurization or depressurization of a k-th stage of filling and drainage, and k is a number of steps of step-by-step filling and drainage;
wherein during the process of filling and draining the internal water loading cavity step by step, a value of pressure gauge is read and a change of the internal water pressure is recorded;
S2, recording the change in the width of the crack of the reinforced concrete lining with the prefabricated crack in real time during the process of filling and draining the internal water loading cavity step by step; and
S3, recording test data such as stress of the steel bar in the lining, circumferential strain of concrete, seepage field, contact force between the lining and the surrounding rock, etc., collected by the reinforcement meter, the strain gauge, the osmometer and the soil pressure gauge in real time during the process of filling and draining the internal water loading cavity step by step.

Compared with the conventional physical model test technology of a pressure tunnel, the present disclosure has the following advantages:

(1) The present disclosure can effectively capture a change process of the width of the crack of the reinforced concrete lining pressure tunnel after the lining cracks during the filling and drainage operation, and solve a problem that the conventional physical model test of the reinforced concrete lining pressure tunnel can only obtain the width of the crack when there is no internal and external water pressure after the test, but cannot obtain the evolution process of the width of the crack in the whole test process.

(2) According to the present disclosure, the geotextile is laid between the reinforced concrete lining with the prefabricated crack and the surrounding rock, so that high internal water can be rapidly filled into a contact portion between the lining and the surrounding rock along the crack after the lining cracks, and the situation that the high internal water flows into the contact portion between the lining and the surrounding rock along the crack after the lining cracks in actual engineering is truly reflected.

(3) According to the present disclosure, the dynamic evolution characteristics of the width of the crack of the lining, the internal water seepage, the lining structure stress, and the contact state between the lining and the surrounding rock of the reinforced concrete lining pressure tunnel during the water filling and drainage operation process can be accurately captured by correspondingly arranging monitoring instruments such as the crack gauge, the strain gauge, the reinforcement meter, the osmometer, and the soil pressure gauge according to the position of the prefabricated crack, which can reflect the mutual feedback process between the four and a cooperative operation mechanism between the reinforced concrete lining and the surrounding rock of the high head pressure tunnel.

### BRIEF DESCRIPTION OF THE DRAWINGS

FIG. 1 is a perspective view of a water filling and drainage test device for reinforced concrete lining pressure tunnel with prefabricated crack according to the present disclosure.

FIG. 2 is a longitudinal cross-sectional view of the water filling and drainage test device for pressure tunnel according to the present disclosure.

FIG. 3 is a transverse cross-sectional view of the filling and drainage test device for pressure tunnel of FIG. 2 according to the present disclosure taken along the line I-I.

FIG. 4 is a transverse cross-sectional view of the pressure tunnel filling and drainage test device of FIG. 2 according to the present disclosure taken along the line II-II.

FIG. 5 is a perspective view of a cylindrical body of the pressure tunnel filling and drainage test device according to the present disclosure.

FIG. 6A is a schematic view of an inner mould for pouring a reinforced concrete lining with prefabricated crack according to the present disclosure.

FIG. 6B is a schematic view of an outer mould for pouring a reinforced concrete lining with prefabricated crack according to the present disclosure.

FIG. 6C is a schematic view of a mould structure after pouring the reinforced concrete lining with prefabricated crack according to the present disclosure.

FIG. 7 is a schematic view of a monitoring section position according to an embodiment of the present disclosure.

FIG. 8A is a schematic view of an arrangement of monitoring instruments on the monitoring section A-A in FIG. 7 of the present disclosure.

FIG. 8B is a schematic view of an arrangement of the monitoring instruments on the monitoring section B-B in FIG. 7 according to the present disclosure.

FIG. 8C is a schematic view of an arrangement of the monitoring instruments on the monitoring section C-C in FIG. 7 according to the present disclosure.

FIG. 8D is a schematic view of an arrangement of the monitoring instruments on the monitoring section D-D in FIG. 7 according to the present disclosure.

FIG. 8E is a schematic view of an arrangement of the monitoring instruments on the monitoring section E-E in FIG. 7 according to the present disclosure.

FIG. 9A is a schematic view of an outer side of a front flange according to the present disclosure.

FIG. 9B is a schematic view of an inner side of the front flange according to the present disclosure.

FIG. 10A is a schematic view of an outer side of a rear flange according to the present disclosure.

FIG. 10B is a schematic view of an inner side of the rear flange according to the present disclosure.

FIG. 11 is a perspective view of a cable guiding outlet at a top of the cylindrical body according to the present disclosure.

FIG. 12 is a schematic diagram of a step-by-step water filling and drainage scheme of the pressure tunnel according to the present disclosure.

1. Cylindrical body; 11. Lug; 111, Bolt connecting hole; 12. Cable guiding outlet, 121. Top flange; 122. Cable guiding hole; 123. Sealing pad; 13. Base; 2. Reinforced concrete lining with prefabricated crack; 21, Circumferential steel bar, 22. Longitudinal steel bar; 23. Crack; 3. Surrounding rock; 4. Geotextile; 5. Front flange; 51, Reinforcing rib; 52. Bolt hole; 53. Pressure gauge; 54. Internal water loading joint; 55. Cable guiding hole; 6. Rear flange; 61. Reinforcing rib; 62. Bolt hole; 63. Inner cavity drainage joint; 7. Inner mould; 71. Vertical steel plate; 8. Outer mould for pouring reinforced concrete lining with prefabricated crack; 91. Reinforcement meter; 92. Strain gauge, 93. Crack gauge; 94. Osmometer; 95. Soil pressure gauge; 101. Sealing ring; 102. Through-threaded rod.

### DETAILED DESCRIPTION OF THE EMBODIMENTS

The present disclosure is further described below with reference to the accompanying drawings and embodiments. It should be understood that these embodiments are only used to explain the present disclosure and not to limit the scope of the present disclosure. After reading the present disclosure, modifications to various equivalent forms of the present disclosure by those skilled in the art fall within the scope defined by the appended claims of the present application.

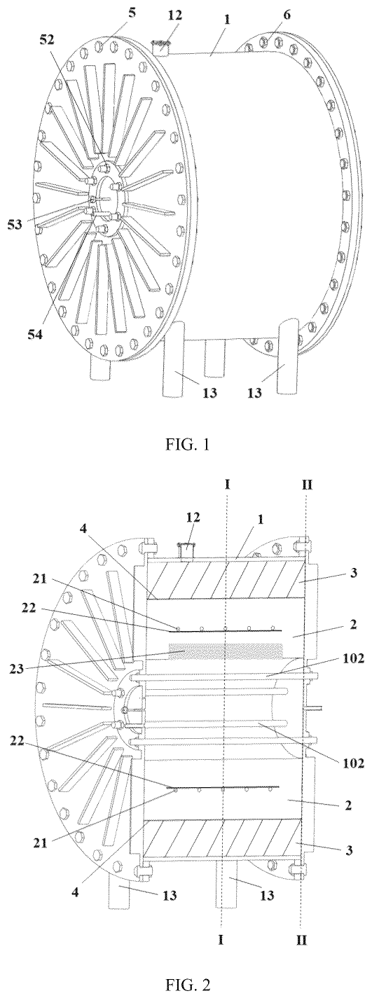

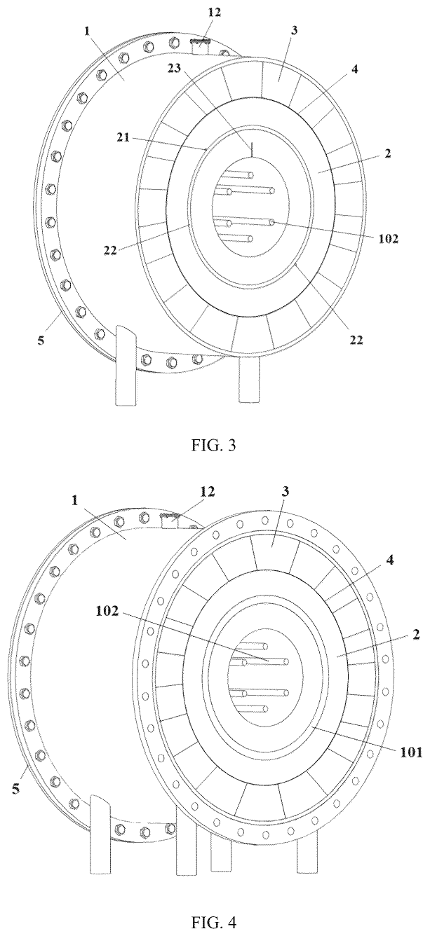

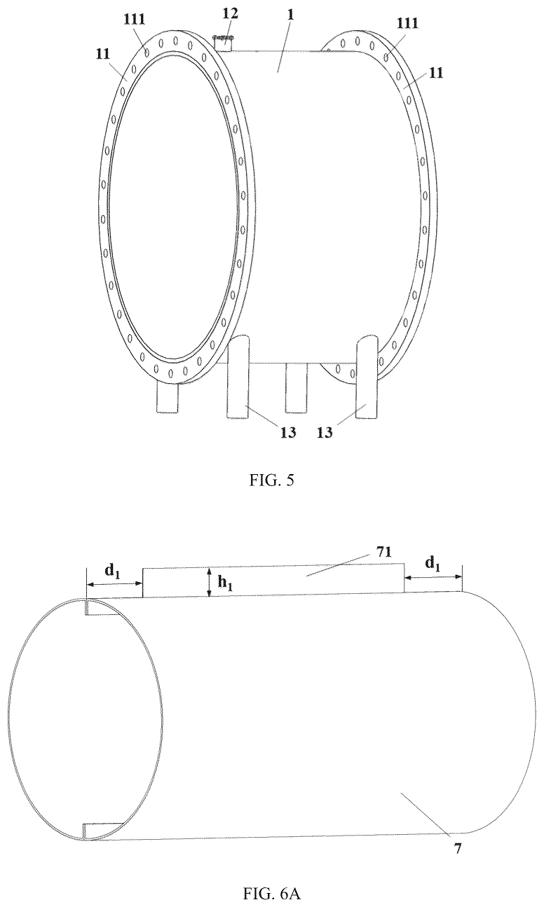

As shown in FIG. 1 to FIG. 5, a water filling and drainage test device for reinforced concrete lining pressure tunnel with prefabricated crack disclosed by the present disclosure is a cylindrical pressure cylinder, which is composed of a cylindrical body 1, a reinforced concrete lining 2 with prefabricated crack, a surrounding rock 3, a geotextile 4, a front flange 5, a rear flange 6, and various monitoring instruments.

The cylindrical body 1 is a rigid metal cylinder, and both ends thereof are provided with lugs 11 configured to be connected to the front flange 5 and rear flange 6. The lug 11 is provided with a plurality of bolt connecting holes 111 spaced apart from each other. A top of the cylindrical body 1 is provided with a cable guiding outlet 12, and a bottom of the cylindrical body 1 is provided with a fixing support 13.

During a water filling test, as the cylindrical body needs to bear a water pressure, a wall thickness of the cylindrical body satisfies the following requirements:

$${d}_{t h r e s h o l d} \geq 1.05 d \qquad ( 1 )$$

wherein d_{threshold} and d are a design value and a standard value (unit: m) of the wall thickness of the cylindrical body, respectively. d is determined by the following formula:

$$d = {r}_{s} ( 1 - \sqrt{\frac{{σ}_{s}^{t} - {p}_{t}}{{σ}_{s}^{t} + {p}_{t}}} ) \qquad ( 2 )$$

wherein rₛ is an outer diameter (m) of the cylindrical body, σₛ^{t} is a ultimate tensile strength (MPa) of steel used for the cylindrical body, and Pₜ is a design head of the pressure tunnel (MPa).

In a preferred embodiment of the present disclosure, the cylindrical body 1 is an iron cylinder having a length of 1.0 m, a diameter of 1.5 m, and a wall thickness of 2 cm.

The surrounding rock 3 abuts against an inner wall of the cylindrical body 1, and the surrounding rock 3 is formed by pouring and curing high-grade concrete. In a preferred embodiment of the present disclosure, the surrounding rock 3 is formed by pouring concrete, and the surrounding rock 3 has a thickness of 23 cm.

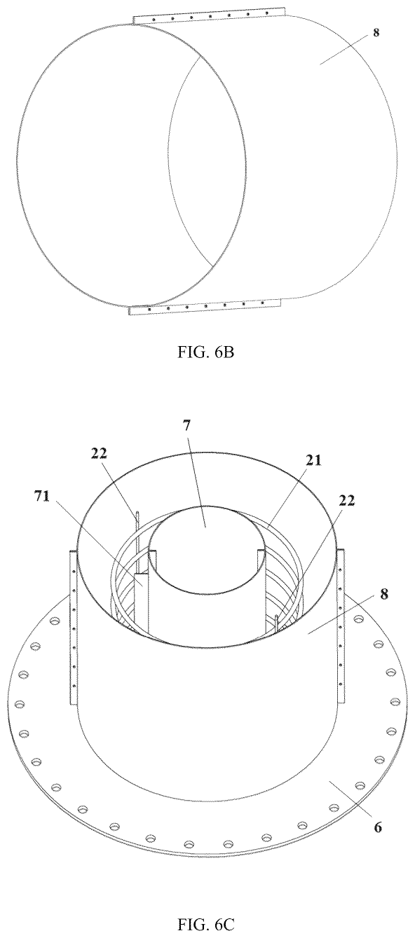

The reinforced concrete lining 2 is provided on an inner side of the surrounding rock 3, and the reinforced concrete lining 2 is formed by pouring and curing concrete. A plurality of circumferential steel bars 21 are spaced apart in the reinforced concrete lining 2 perpendicular to a longitudinal axis of the tunnel, and a plurality of longitudinal steel bars 22 are spaced apart in the reinforced concrete lining 2 parallel to the longitudinal axis of the tunnel. In order to study the dynamic evolution process of a plurality of physical characteristics in the water filling and drainage operation process of the pressure tunnel after the concrete lining of the pressure tunnel cracks, in a preferred embodiment of the present disclosure, a crack 23 parallel to the longitudinal axis of the pressure tunnel is preset on an inner wall of the reinforced concrete lining of the pressure tunnel. A depth h₁ of the crack 23 is 6 cm, and distances d₁ between both ends of the crack 23 and both ends of the cylindrical body are 15 cm (See FIG. 6A).

FIG. 6A is a schematic view of an inner mould for pouring the reinforced concrete lining with prefabricated crack according to the present disclosure, FIG. 6B is a schematic view of an outer mould for pouring a reinforced concrete lining with prefabricated crack according to the present disclosure, and FIG. 6C is a schematic view of the inner mould and the outer mould after being assembled. As shown in FIG. 6A to FIG. 6C, a vertical steel plate 71 is provided on an outer wall of the inner mould 7 for pouring the concrete lining and is parallel to an axis of the pressure tunnel, and the vertical steel plate 71 is configured to form the prefabricated crack 23 when pouring the lining. A width h₁ of the vertical steel plate 71 is 6 cm, and distances d₁ between both ends of the vertical steel plate 71 and both ends of the inner mould 7 are 15 cm. The vertical steel plate 71 may be welded to the outer wall of the inner mould 7, or may be fixed to the outer wall of the inner mould by bolts and nuts. When the concrete lining 2 is poured, the inner mould 7, the outer mould 8, and the rear flange 6 are assembled to form a combined mould for pouring the concrete lining. An inner diameter of the inner mould 7, an inner diameter of the outer mould 8, and a distance between the inner mould 7 and the outer mould 8 can be adjusted according to a thickness of the reinforced concrete lining 2 to be poured, then the circumferential steel bar 21 and the longitudinal steel bars 22 are bound between the inner mould and the outer mold, and then the concrete is poured to form the reinforced concrete lining pressure tunnel with the prefabricated crack.

After the pressure tunnel is filled with water, the reinforced concrete lining 2 will crack along the prefabricated cracks 23. In order to ensure that after the concrete lining cracks, the internal water in the pressure tunnel seeps out along the crack 23 and enters the lining, and flows rapidly between the lining 2 and the surrounding rock 3 when reaching between the lining 2 and the surrounding rock 3, instead of further entering the surrounding rock 3, which causes the surrounding rock 3 to separate from the lining 2 in a long time, and the reinforced concrete lining 2 is prevented from generating new cracks in the subsequent water filling process of the pressure tunnel to affect the pattern of the change in the width of the prefabricated crack 23, and further affects the analysis of the dynamic evolution process of the water seepage evolution in the pressure tunnel, the stress of the lining structure, and the contact state between the lining and the surrounding rock caused by the change in the width of the crack 23, a layer of the geotextile 4 is laid between the outer wall of the reinforced concrete lining 2 with the prefabricated crack and the inner wall of the surrounding rock 3.

A thickness of the geotextile 4 is configured such that a circumferential stress σ_{θ} and a circumferential strain ε_{θ} of the reinforced concrete lining 2 with the prefabricated crack satisfy the following relationship:

$${σ}_{θ 1} < {σ}_{θ} < {σ}_{θ 2} \qquad ( 3 )$$

$${ε}_{θ 1} < {ε}_{θ} < {ε}_{θ 2} \qquad ( 4 )$$

where σ_{θ1} and ε_{θ1} are a circumferential stress and a circumferential strain of the outer wall of the reinforced concrete lining with the prefabricated crack under rigid constraint, respectively;
where σ_{θ2} and ε_{θ2} are a circumferential stress and a circumferential strain of the lining when the outer wall of the reinforced concrete lining with the prefabricated crack is a free boundary, respectively.
σ_{θ1}, ε_{θ2}, σ_{θ2} and ε_{θ2} are determined from the following formulas:

$${σ}_{θ 1} = \frac{\frac{1 - 2 υ}{{r}^{2}} - \frac{1}{{b}^{2}}}{\frac{1 - 2 υ}{{a}^{2}} + \frac{1}{{b}^{2}}} {p}_{crack} \qquad ( 5 )$$

$${ε}_{θ 1} = \frac{( 1 - 2 υ ) ( 1 + υ )}{E} \frac{\frac{1}{{r}^{2}} - \frac{1}{{b}^{2}}}{\frac{1 - 2 υ}{{a}^{2}} + \frac{1}{{b}^{2}}} {p}_{crack} \qquad ( 6 )$$

$${σ}_{θ 2} = \frac{{a}^{2} {b}^{2} {p}_{crack}}{{b}^{2} - {a}^{2}} \frac{1}{{r}^{2}} + \frac{{a}^{2} {p}_{crack}}{{b}^{2} - a} \qquad ( 7 )$$

$${ε}_{θ 2} = \frac{1}{E} [ ( 1 + υ ) \frac{{a}^{2} {b}^{2} {p}_{crack}}{{b}^{2} - {a}^{2}} \frac{1}{{r}^{2}} + ( 1 - υ ) \frac{{a}^{2} {p}_{crack}}{{b}^{2} - {a}^{2}} ] \qquad ( 8 )$$

where p_{crack} is an estimated value of internal water pressure (MPa) when a pressure tunnel lining cracks, and a value of p_{crack} is 1.1 MPa.
a is an inner diameter of the reinforced concrete lining with the prefabricated crack, b is an outer diameter of the reinforced concrete lining with the prefabricated crack, and r is a distance from any point in the reinforced concrete lining with the prefabricated crack to a center thereof.
v is a Poisson's ratio of a material of the reinforced concrete lining with the prefabricated crack.
E is an elastic modulus of the material of the reinforced concrete lining with prefabricated crack.

In a preferred embodiment of the present disclosure, the geotextile 4 is laid on the outer wall of the reinforced concrete lining 2 with the prefabricated crack and is adhered with a flexible adhesive.

In the present disclosure, the crack 23 is prefabricated in the reinforced concrete lining 2 to induce the lining to crack. In order to accurately capture the filling and drainage operation state of the pressure tunnel after the reinforced concrete lining cracks, observe and analyze a change in the width of the crack and the dynamic change process of the physical characteristics of the pressure tunnel that may be caused by the change in the width of the crack, various monitoring instruments are arranged in the reinforced concrete lining, including but not limited to the plurality of reinforcement meters 91, the strain gauges 92, the crack gauge 93, the osmometer 94, and the soil pressure gauges 95. The arranged crack gauge 93 is configured to monitor the change in the width of the crack 23 during the filling and drainage process, and monitoring instruments such as the reinforcement meters 91, the strain gauges 92, the osmometer 94, and the soil pressure gauges 95 are arranged according to a position of the prefabricated crack 23 to capture the operation characteristics of the pressure tunnel during the filling and drainage process.

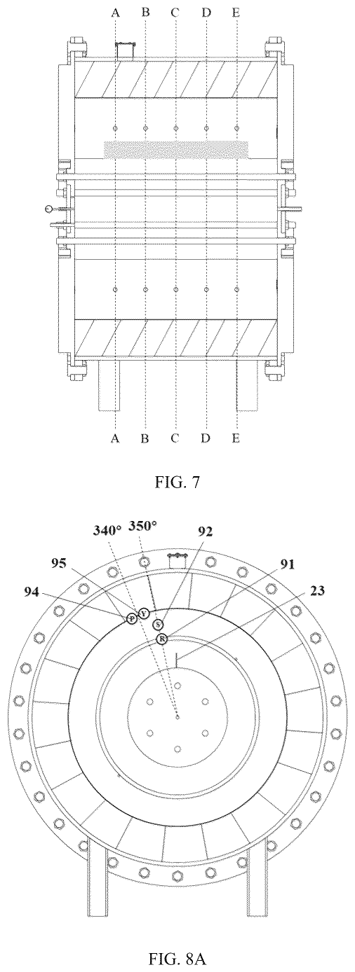

As shown in FIG. 7, in order to obtain test data such as steel bar stress, concrete circumferential strain, change in the width of the crack of the lining, seepage field, contact force between the lining and the surrounding rock and the like during the filling and drainage process of the pressure tunnel, in the reinforced concrete lining with the prefabricated crack, five monitoring sections A-A, B-B, C-C, D-D, and E-E perpendicular to an axis of the pressure tunnel are selected at intervals along the axis of the pressure tunnel.

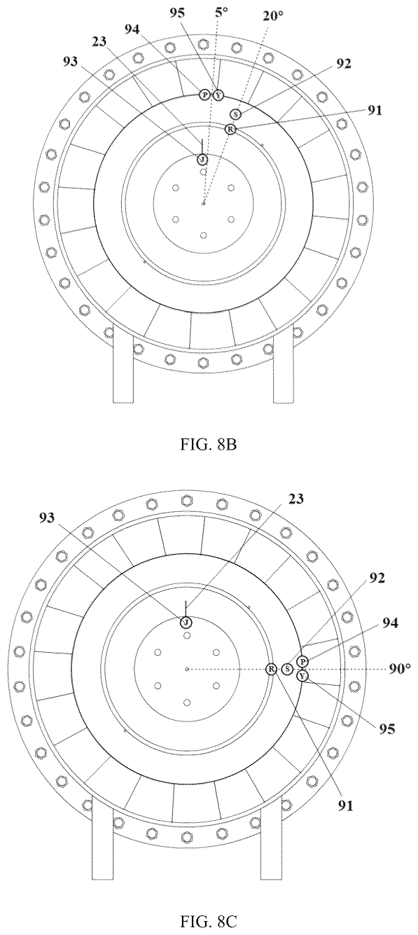

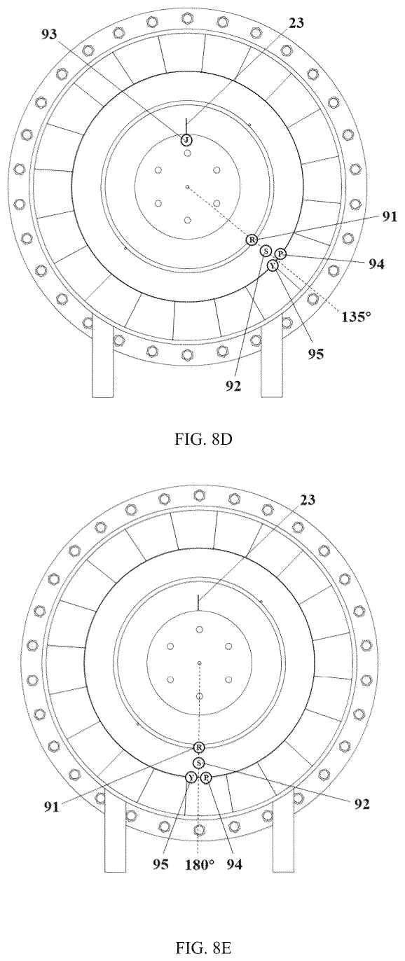

As shown in FIG. 8B to FIG. 8D, the crack gauge 93 is arranged at the crack 23 of the monitoring section with the prefabricated crack 23, such as the monitoring sections B-B, C-C, and D-D.

As shown in FIG. 8 A to FIG. 8 E, taking a top center of the cylindrical body 1 as a direction of 0°, each reinforcement meter 91 is respectively arranged at positions of 350°, 20°, 90°, 135° and 180° of the monitoring sections A-A, B-B, C-C, D-D and E-E in a clockwise direction, and a distance between the reinforcement meter 91 on each monitoring section and a central axis of the pressure tunnel is equal. In the embodiment, only one reinforcement meter can be arranged on each monitoring section. For example, one reinforcement meter is arranged at the position of 350° of the monitoring section A-A, one reinforcement meter is arranged at the position of 20° of the monitoring section B-B, one reinforcement meter is arranged at the position of 90° of the monitoring section C-C, one reinforcement meter is arranged at the position of 135° of the monitoring section D-D, and one reinforcement meter is arranged at the position of 180° of the monitoring section E-E. Alternatively, one reinforcement meter can be arranged at the positions of 350°, 20°, 90°, 135° and 180° of each monitoring section.

Taking the top center of the cylindrical body as the direction of 0°, each strain gauge 92 is respectively arranged at positions of 350°, 20°, 90°, 135° and 180° of the monitoring sections A-A, B-B, C-C, D-D and E-E in the clockwise direction, and a distance between the strain gauge 92 on each monitoring section and the central axis of the pressure tunnel is equal. In the embodiment, only one strain gauge 92 can be arranged on each monitoring section. For example, one strain gauge is arranged at the position of 350° of the monitoring section A-A, one strain gauge is arranged at the position of 20° of the monitoring section B-B, one strain gauge is arranged at the position of 90° of the monitoring section C-C, one strain gauge is arranged at the position of 135° of the monitoring section D-D, and one strain gauge is arranged at the position of 180° of the monitoring section E-E. Alternatively, one strain gauge can be arranged at the positions of 350°, 20°, 90°, 135° and 180° of each monitoring section.

Similarly, taking the top center of the cylindrical body 1 as the direction of 0°, each soil pressure gauge 94 and each osmometer 95 are respectively arranged at the positions of 340°, 5°, 90°, 135° and 180° of the monitoring sections A-A, B-B, C-C, D-D and E-E and on an outer wall of the lining 2 in the clockwise direction, and a distance between the soil pressure gauge 94 and the osmometer 95 is 6 cm.

In the embodiment, only one soil pressure gauge 94 and one osmometer 95 can be arranged on each monitoring section. For example, one soil pressure gauge 94 and one osmometer 95 are arranged at the position of 340° of the monitoring section A-A, one soil pressure gauge 94 and one osmometer 95 are arranged at the position of 5° of the monitoring section B-B, one soil pressure gauge 94 and one osmometer 95 are arranged at the position of 90° of the monitoring section C-C, one soil pressure gauge 94 and one osmometer 95 are arranged at the position of 135° of the monitoring section D-D, and one soil pressure gauge 94 and one osmometer 95 are arranged at the position of 180° of the monitoring section E-E. Alternatively, one soil pressure gauge 94 and one osmometer 95 can be arranged at the positions of 340°, 5°, 90°, 135° and 180° of each monitoring section.

Before pouring the reinforced concrete lining with the prefabricated crack, the reinforcement meter 91 is bound or welded to the circumferential steel bar 21. The strain gauge 92 is connected to an outer wall of inner mould 7 of the lining or an inner wall of the outer mould 8 of the lining through a connecting member. The soil pressure gauge 95 and the osmometer 96 are fixed to an inner wall of the outer mould 8 of the lining through a connecting member. After the reinforced concrete lining is poured, the crack gauge 93 is fixed on an inner wall of the prefabricated crack 23.

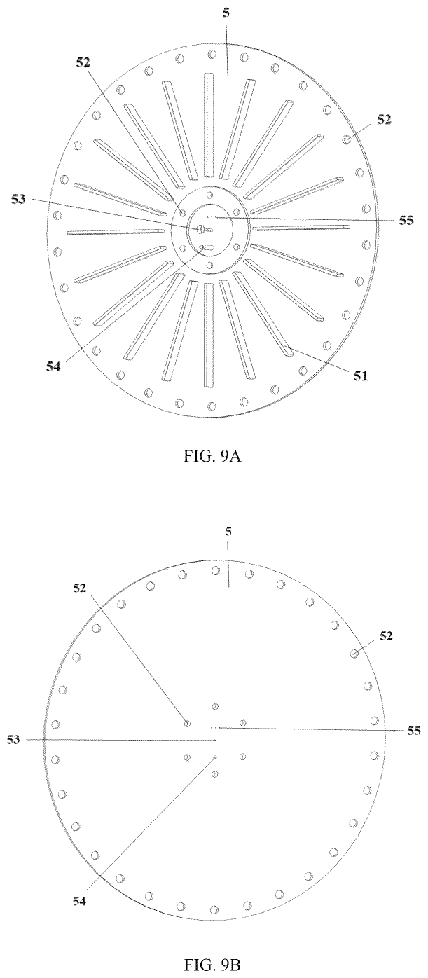

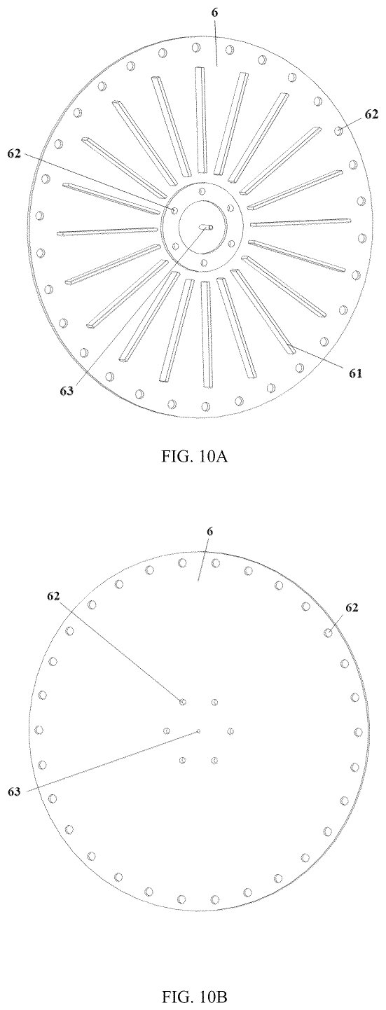

In order to simulate the operation state of filling and drainage of the pressure tunnel, as shown in FIGS. 1 and 2, the front flange 5 and the rear flange 6 are respectively connected and fixed to both ends of the cylindrical body 1. The inner wall of the reinforced concrete lining 2 with the prefabricated crack, the front flange 5, and the rear flange 6 form a closed internal water loading cavity that can be filled and drained. As shown in FIGS. 9A and 9B, an outer side of the front flange 5 is provided with a plurality of reinforcing ribs 51, and the outer side of the front flange 5 is provided with bolt holes 52 configured to be connected to the cylindrical body 1. A pressure gauge 53 is mounted in a middle area of the front flange 5 corresponding to the hole of the pressure tunnel, and an internal water loading joint 54 and a cable guiding hole 55 are provided in the middle area of the front flange 5. As shown in FIGS. 10A and 10B, an outer side of the rear flange 6 is also provided with a plurality of reinforcing ribs 61, and the outer side of the rear flange 6 is provided with bolt holes 62 configured to be connected with the cylindrical body 1. An inner cavity drainage joint 63 is provided in a middle area of the rear flange 6 corresponding to hole of the pressure tunnel.

In order to enhance the sealing performance, sealing rings are provided between the front flange 5, the rear flange 6, and the cylindrical body 1. The front flange and the rear flange are further connected by a through-threaded rod 102 extending through the pressure tunnel hole.

During the test, the internal water is filled into the internal water loading cavity through a pressurized water pump and the internal water loading joint 54 of the front flange, that is, the internal water is injected into the pressure tunnel. After the test, the internal water is drain through the inner cavity drainage joint 63 of the rear flange. In the whole test process, the plurality of monitoring instruments are used to monitor the dynamic evolution characteristics of the internal water seepage evolution, the lining structure stress, the change in the width of the crack of the lining and the dynamic evolution characteristics of the contact state between the lining and the surrounding rock in the reinforced concrete lined pressure tunnel during the filling and drainage process, so as to clarify the mutual feeding process between the four, and to reveal the cooperative operating mechanism between the reinforced concrete lining and the surrounding rock in a high-head pressure tunnel.

Power lines and data lines of the plurality of monitoring instruments embedded in the lining extend through the cable guiding hole 55 of the front flange and the cable guiding outlet 12 at the top of the cylindrical body 1 according to the principle of proximity. As shown in FIG. 11, a top flange 121 is fixed to the cable guiding outlet 12 at the top of the cylindrical body 1 through bolts, the top flange 121 is provided with a cable guiding hole 122, and a sealing pad 123 is provided between the top flange 121 and the cable guiding outlet 12.

The method for performing a water filling and drainage test for pressure tunnel using the above-mentioned filling and drainage test device for reinforced concrete lining pressure tunnel with prefabricated crack includes the following steps:
S1, the internal water loading cavity formed by the test device is filled and drained step by step to simulate an operating state of water pressure loading and unloading in the pressure tunnel.

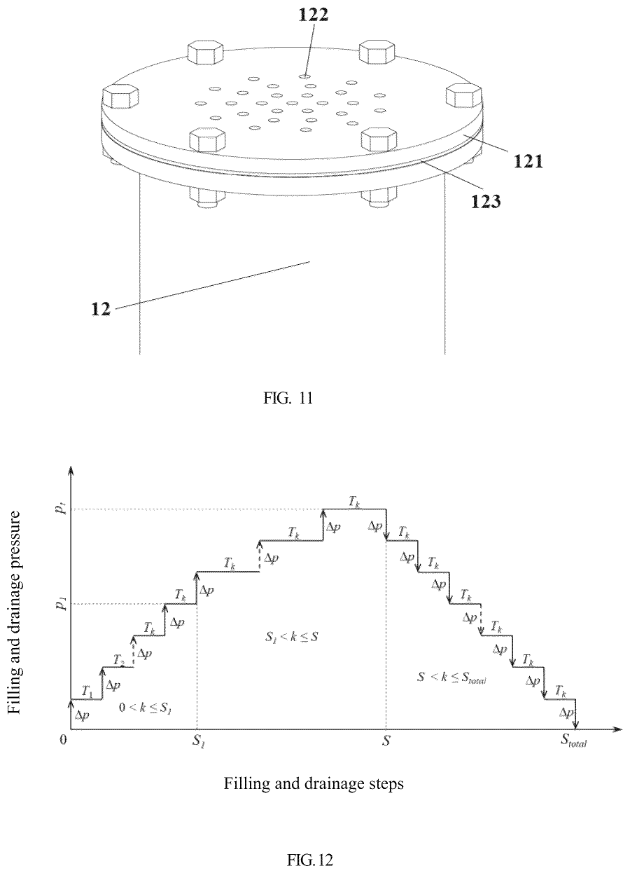

The pressurized water pump is connected to the internal water loading joint 54 of the front flange. As shown in FIG. 12, the internal water loading cavity is filled with water step by step. When the step-by-step filling stage is completed, the inner cavity drainage joint 63 of the rear flange is opened to drain the water step by step.
A number of water filling steps, a total number of water filling steps, and a total number of filling and drainage steps when the water filling pressure is 0.5 Mpa are as follows:

$${S}_{l} = \frac{{p}_{l}}{Δ p} \qquad ( 9 )$$

$$S = \frac{{p}_{t}}{Δ p} \qquad ( 10 )$$

$${S}_{total} = 2 \times S \qquad ( 11 )$$

wherein, S₁ is a number of steps when the water filling pressure is equal to 0.5 Mpa, and S is a total number of water filling steps. Sₜₒₜₐₗ is a total number of water filling and drainage steps. P₁ is a water filling pressure of 0.5 Mpa, pₜ is a design head of the pressure tunnel (MPa), which is 1.5 MPa, and Δp is a loading and unloading amplitude (MPa) of step-by-step water filling and drainage pressure, which is 0.05 MPa.

When the internal water loading cavity is filled and drained step by step, a duration of pressurization or depressurization of each stage of filling and draining is:

$${T}_{k} = \{ \begin{matrix}120 s & , & 0 < k \leq {S}_{l} \\ 240 s & , & {S}_{l} < k \leq S \\ 120 s & , & S < k \leq {S}_{total}\end{matrix} \qquad ( 12 )$$

wherein, Tₖ is the duration of pressurization or depressurization of a k-th stage of filling and drainage, and k is a number of steps of step-by-step filling and drainage.

During the process of filling and draining the internal water loading cavity step by step, a value of pressure gauge 53 is read and a change of the internal water pressure is recorded.
S2, during the process of filling and draining the internal water loading cavity step by step, the change in the width of the crack of the reinforced concrete lining with the prefabricated crack is recorded in real time.
S3, in the process of filling and draining the internal water loading cavity step by step, the test data such as the stress of the steel bar in the lining, the circumferential strain of concrete, the seepage field, the contact force between the lining and the surrounding rock, etc., collected by the reinforcement meter, the strain gauge, the osmometer and the soil pressure gauge are recorded in real time.

Compared with the prior art, by prefabricating the crack in the reinforced concrete lining to induce the lining to crack from here, so that not only the change in the width of the crack in the filling and drainage process can be monitored by arranging the crack gauge, but also the operation characteristics of the pressure tunnel during the filling and drainage process can be accurately captured by correspondingly arranging monitoring instruments such as the strain gauge, the reinforcement meter, the osmometer and the soil pressure gauge according to the position of the prefabricated crack. In addition, the geotextile with a certain thickness is laid between the lining and the surrounding rock to ensure that after the lining cracks, the internal water seeps out along the crack and enters a space between the lining and the surrounding rock to flow rapidly, so that the lining is changed from tension to compression, and the lining is prevented from generating new cracks in the subsequent water filling process to influence the change rule of the width of the prefabricated crack. It provides a basis for studying and analyzing the dynamic evolution characteristics of the internal water seepage, the lining structure stress, the width of the crack of the lining, and the contact state between the lining and the surrounding rock in the reinforced concrete lining pressure tunnel during the filling and drainage process, to clarify the mutual feeding process between the four, and to reveal the cooperative operating mechanism between the reinforced concrete lining and the surrounding rock in a high-head pressure tunnel.

Finally, it should be noted that the embodiments described above are only for explaining the technical solution of the present disclosure, not to limit it. Although the present disclosure has been described in detail with reference to the foregoing embodiments, those skilled in the art should understand that the technical solutions described in the foregoing embodiments can still be modified, or some or all of the technical features thereof can be equivalently replaced. These modifications or replacements do not cause the essence of the corresponding technical solutions to depart from the scope of the technical solutions of the embodiments of the present disclosure.

1. A water filling and drainage test device for reinforced concrete lining pressure tunnel with prefabricated crack, comprising:
a cylindrical body, a reinforced concrete lining with a prefabricated crack, a surrounding rock, a geotextile, a front flange, a rear flange, and monitoring instruments;
wherein the cylindrical body is a rigid metal cylinder, and a wall thickness d_{threshold} of the cylindrical body satisfies the following requirements:
$${d}_{t h r e s h o l d} \geq 1.05 d \qquad ( 1 )$$
wherein d_{threshold} and d are a design value and a standard value (m) of the wall thickness of the cylindrical body, respectively, and dis determined by the following formula:
$$d = {r}_{s} ( 1 - \sqrt{\frac{{σ}_{s}^{t} - {p}_{t}}{{σ}_{s}^{t} + {p}_{t}}} ) \qquad ( 2 )$$
wherein rₛ is an outer diameter (unit: m) of the cylindrical body, σₛ^{t} is a ultimate tensile strength (unit: MPa) of steel used for the cylindrical body, and Pₜ is a design head of a pressure tunnel (unit: MPa);
wherein the surrounding rock abuts against an inner wall of the cylindrical body, the reinforced concrete lining with prefabricated crack is provided on an inner side of the surrounding rock, and the front flange and the rear flange are respectively fixed to both ends of the cylindrical body to form a closed internal water loading cavity capable of being filled and drained;
wherein the monitoring instruments include a crack gauge configured to monitor a change in a width of the crack during the filling and draining process, a reinforcement meter, a strain gauge, an osmometer, and a soil pressure gauge that are each configured to monitor an operation condition in the pressure tunnel, and the monitoring instruments are provided in an inner wall of the crack, in the reinforced concrete lining, and between the reinforced concrete lining and the surrounding rock;
wherein the geotextile is laid between the surrounding rock and the reinforced concrete lining, and a thickness of the geotextile is configured such that a circumferential stress σ_{θ} and a circumferential strain ε_{θ} of the reinforced concrete lining with the prefabricated crack satisfy the following relationship:
$${σ}_{θ 1} < {σ}_{θ} < {σ}_{θ 2} \qquad ( 3 )$$
$${ε}_{θ 1} < {ε}_{θ} < {ε}_{θ 2} \qquad ( 4 )$$
wherein σ_{θ1} and ε_{θ1} are respectively a circumferential stress and a circumferential strain of an outer wall of the reinforced concrete lining with the prefabricated crack under rigid constraint;
wherein σ_{θ2} and ε_{θ2} are respectively a circumferential stress and a circumferential strain of the lining when the outer wall of the reinforced concrete lining with the prefabricated crack is a free boundary;
wherein σ_{θ1}, ε_{θ1}, σ_{θ2} and ε_{θ2} are respectively determined with the following formulas:
$${σ}_{θ 1} = \frac{\frac{1 - 2 υ}{{r}^{2}} - \frac{1}{{b}^{2}}}{\frac{1 - 2 υ}{{a}^{2}} + \frac{1}{{b}^{2}}} {p}_{crack} \qquad ( 5 )$$
$${ε}_{θ 1} = \frac{( 1 - 2 υ ) ( 1 + υ )}{E} \frac{\frac{1}{{r}^{2}} - \frac{1}{{b}^{2}}}{\frac{1 - 2 υ}{{a}^{2}} + \frac{1}{{b}^{2}}} {p}_{crack} \qquad ( 6 )$$
$${σ}_{θ 2} = \frac{{a}^{2} {b}^{2} {p}_{crack}}{{b}^{2} - {a}^{2}} \frac{1}{{r}^{2}} + \frac{{a}^{2} {p}_{crack}}{{b}^{2} - a} \qquad ( 7 )$$
$${ε}_{θ 2} = \frac{1}{E} [ ( 1 + υ ) \frac{{a}^{2} {b}^{2} {p}_{crack}}{{b}^{2} - {a}^{2}} \frac{1}{{r}^{2}} + ( 1 - υ ) \frac{{a}^{2} {p}_{crack}}{{b}^{2} - {a}^{2}} ] \qquad ( 8 )$$
wherein p_{crack} is an estimated value of internal water pressure (unit: MPa) when a pressure tunnel lining cracks;
a is an inner diameter of the reinforced concrete lining with the prefabricated crack, b is an outer diameter of the reinforced concrete lining with the prefabricated crack, and r is a distance from any point in the reinforced concrete lining with the prefabricated crack to a center thereof,
v is a Poisson's ratio of a material of the reinforced concrete lining with the prefabricated crack; and
E is an elastic modulus of the material of the reinforced concrete lining with prefabricated crack.

2. The water filling and drainage test device for reinforced concrete lining pressure tunnel with prefabricated crack according to claim 1, wherein the reinforced concrete lining with the prefabricated crack is formed by pouring and curing concrete, a plurality of circumferential steel bars are spaced apart in the reinforced concrete lining perpendicular to a longitudinal axis of the pressure tunnel, a plurality of longitudinal steel bars are spaced apart in the reinforced concrete lining parallel to the longitudinal axis of the tunnel, and a crack is preset on an inner wall of the reinforced concrete lining.

3. The water filling and drainage test device for reinforced concrete lining pressure tunnel with prefabricated crack according to claim 2, wherein in the reinforced concrete lining with the prefabricated crack, five monitoring sections A-A, B-B, C-C, D-D, and E-E perpendicular to an axis of the pressure tunnel are selected at intervals along the axis of the pressure tunnel; the crack gauge is arranged at the crack of the monitoring section with the prefabricated crack; taking a top center of the cylindrical body as a direction of 0°, the reinforcement meter and the strain gauge are respectively arranged at positions of 350°, 20°, 90°, 135° and 180° of the monitoring sections A-A, B-B, C-C, D-D and E-E in a clockwise direction, and a distance between the reinforcement meter and a central axis of the pressure tunnel is equal to a distance between the strain gauge and a central axis of the pressure tunnel on each monitoring section; taking the top center of the cylindrical body as the direction of 0°, the soil pressure gauge and the osmometer are respectively arranged at positions of 340°, 5°, 90°, 135° and 180° of the monitoring sections A-A, B-B, C-C, D-D and E-E in the clockwise direction and on an outer wall of the lining, and a distance between the soil pressure gauge and the osmometer is 6 cm.

4. The water filling and drainage test device for reinforced concrete lining pressure tunnel with prefabricated crack according to claim 3, wherein the reinforcement meter is bound or welded to the circumferential steel bar, the strain gauge is embedded in the reinforced concrete lining, and the soil pressure gauge and the osmometer are arranged on the outer wall of the reinforced concrete lining.

5. The water filling and drainage test device for reinforced concrete lining pressure tunnel with prefabricated crack according to claim 4, wherein a depth of the crack is about 6 cm, and distances between both ends of the crack and both ends of the cylindrical body are each about 15 cm.

6. The water filling and drainage test device for reinforced concrete lining pressure tunnel with prefabricated crack according to claim 5, wherein an outer side of the front flange is provided with a plurality of reinforcing ribs, the outer side of the front flange is provided with bolt holes configured to be connected to the cylindrical body, a pressure gauge is mounted in a middle area of the front flange corresponding to hole of the pressure tunnel, and an internal water loading joint and a cable guiding hole are provided in the middle area of the front flange; an outer side of the rear flange is also provided with a plurality of reinforcing ribs, the outer side of the rear flange is provided with bolt holes configured to be connected to the cylindrical body, and an inner cavity drainage joint is provided in a middle area of the rear flange corresponding to hole of the pressure tunnel; and
sealing rings are provided between the front flange, the rear flange, and the cylindrical body.

7. A method for performing a water filling and drainage test for pressure tunnel using the water filling and drainage test device for reinforced concrete lining pressure tunnel with prefabricated crack according to claim 1, comprising the following steps:
S1, filling and draining water into an internal water loading cavity formed by the test device step by step to simulate an operating state of water pressure loading and unloading in the pressure tunnel;
connecting a pressurized water pump to an internal water loading joint of the front flange, filling the internal water loading cavity with water step by step, and opening the inner cavity drainage joint of the rear flange to drain the water step by step when step-by-step filling stage is completed;
wherein a number of water filling steps, a total number of water filling steps, and a total number of filling and drainage steps when the water filling pressure is 0.5 Mpa are as follows:
$${S}_{l} = \frac{{p}_{l}}{Δ p} \qquad ( 9 )$$
$$S = \frac{{p}_{t}}{Δ p} \qquad ( 10 )$$
$${S}_{total} = 2 \times S \qquad ( 11 )$$
wherein S₁ is a number of steps when the water filling pressure is equal to 0.5 Mpa, S is a total number of water filling steps, Sₜₒₜₐₗ is a total number of water filling and drainage steps, P₁ is a water filling pressure of 0.5 Mpa, pₜ is a design head of the pressure tunnel (unit: MPa), which is 1.5 MPa, and Δp is a loading and unloading amplitude (unit: MPa) of step-by-step water filling and drainage pressure, which is 0.05 MPa;
wherein when the internal water loading cavity is filled and drained step by step, a duration of pressurization or depressurization of each stage of filling and draining is:
$${T}_{k} = \{ \begin{matrix}120 s & , & 0 < k \leq {S}_{l} \\ 240 s & , & {S}_{l} < k \leq S \\ 120 s & , & S < k \leq {S}_{total}\end{matrix} \qquad ( 12 )$$
wherein Tₖ is the duration of pressurization or depressurization of a k-th stage of filling and drainage, and k is a number of steps of step-by-step filling and drainage;
wherein during the process of filling and draining the internal water loading cavity step by step, a value of pressure gauge is read and a change of the internal water pressure is recorded;
S2, recording the change in the width of the crack of the reinforced concrete lining with the prefabricated crack in real time during the process of filling and draining the internal water loading cavity step by step; and
S3, recording test data such as stress of the steel bar in the lining, circumferential strain of concrete, seepage field, contact force between the lining and the surrounding rock, etc., collected by the reinforcement meter, the strain gauge, the osmometer and the soil pressure gauge in real time during the process of filling and draining the internal water loading cavity step by step.
